(19) United States
(12) Patent Application Publication
(10) Pub. No.: US 2026/0196035 A1
(43) Pub. Date: Jul. 9, 2026

(54) METHOD AND SYSTEM FOR GENERATING 3D SCENE GRAPH USING MULTIPLE AGENTS

(71) Applicant: GWANGJU INSTITUTE OF SCIENCE AND TECHNOLOGY, Gwangju (KR)

(72) Inventors: Uehwan KIM, Gwangju (KR); Yi Rum KIM, Gwangju (KR)

(73) Assignee: GWANGJU INSTITUTE OF SCIENCE AND TECHNOLOGY, Gwangju (KR)

(21) Appl. No.: 19/437,693

(22) Filed: Dec. 31, 2025

(30) Foreign Application Priority Data
Jan. 3, 2025 (KR) 10-2025-0001046

(51) Int. Cl. G06V 10/86; G06T 7/11; G06T 7/73; G06V 10/44; G06V 10/74; G06V 10/82

(52) U.S. Cl. CPC G06V 10/86; G06T 7/11; G06T 7/73; G06V 10/44; G06V 10/761; G06V 10/82; G06T 2207/10024; G06T 2207/10028; G06T 2207/20072; G06T 2207/20221; G06T 2207/30244

(57) ABSTRACT

A method and system for generating a three-dimensional scene graph using multiple agents. RGB-D data and camera pose data for a specific space among the large-scale space is acquired; the specific space is segmented into a plurality of segments and a three-dimensional global segmentation map is generated; point clouds of respective ones of the plurality of segments and spatial attribute information of respective ones of the plurality of segments are extracted.

### CROSS REFERENCE TO RELATED APPLICATION

The present application claims priority to Korean Patent Application No. 10-2025-0001046, filed Jan. 3, 2025, the entire contents of which are hereby incorporated by reference in its entirety.

### BACKGROUND

### Field

The present invention relates to a method and system for generating a three-dimensional (3D) scene graph using multiple agents.

### Description of the Related Art

Three-dimensional scene understanding has a meaning beyond simply recognizing a thing (or an object) and identifying a position in a three-dimensional space (or environment). Included here is the understanding of an environment and a context where the corresponding thing is placed, and the types of mutual relationships made with other things. Such three-dimensional scene understanding is a very important element in various application fields such as robot navigation, autonomous systems, augmented reality (AR) and virtual reality (VR). For example, in robot navigation, in order for a robot to move autonomously, based on three-dimensional information of a surrounding environment, relationships with things need to be understood, and such must be capable of being analyzed in real time. Also, in augmented reality and virtual reality, when a user interacts with virtual things, because the corresponding things must be naturally arranged within a real environment, accurate three-dimensional scene understanding is required.

In connection therewith, in the context of three-dimensional scene understanding, a three-dimensional scene graph provides important information for three-dimensional scene understanding. A three-dimensional scene graph, by visually expressing things (or nodes) in a three-dimensional space and relationships (edges) among things, enables visualization and understanding of a structure and interactions of an entire space. Generating such a three-dimensional scene graph in real time is important for robots or autonomous systems to perform tasks quickly and accurately in wide and complex environments.

Accordingly, research for generating a three-dimensional scene graph in real time is being actively conducted recently. However, prior research focuses on a method that, by using a single agent, that is, one robot or device, independently analyzes a three-dimensional scene and generates a three-dimensional scene graph. A single-agent method may be effective in a limited space, but in a large-scale space consisting of multiple rooms, time and resources may be greatly consumed.

For example, because a single agent is slow in processing a space, a very long time is required to convert large buildings or complex environments into a three-dimensional graph. In addition, in cases where there are state changes, such as when things in a room are moving or new things are being added, a single agent does not reflect such space changes in real time. That is, the single-agent method has limitations due to difficulties of such being utilized in large-scale spaces, or environments with frequent dynamic changes.

In order to solve this, in the present invention, a method of using multiple agents, capable of quickly exploring large-scale spaces in real time, and quickly and efficiently generating a three-dimensional scene graph for large-scale spaces, is proposed.

### SUMMARY

The present invention is directed to providing a method and system for generating a three-dimensional scene graph using multiple agents.

More specifically, the present invention is directed to providing a method and system for generating a three-dimensional scene graph using multiple agents, which is capable of, by using multiple agents, exploring large-scale spaces, and generating in real time a three-dimensional scene graph for large-scale spaces.

Further, the present invention is directed to providing a method and system for generating a three-dimensional scene graph using multiple agents, which is capable of generating in real time a three-dimensional scene graph for large-scale spaces that multiple agents, by cooperating with each other, have explored.

Further, the present invention is directed to providing a method and system for generating a three-dimensional scene graph using multiple agents, which is capable of generating in real time a three-dimensional scene graph for large-scale spaces that multiple agents, by cooperating with each other, have explored.

Moreover, the present invention is directed to providing a method and system of generating a three-dimensional scene graph using multiple agents, which can generate 3D scene graphs in real time with respect to spaces explored by each agent, and can combine and update the generated three-dimensional scene graphs.

To solve the aforementioned problems, a method for generating a three-dimensional scene graph using multiple agents, according to the present invention may comprise: acquiring, from at least one agent among the plurality of agents, RGB-D data and camera pose data for a specific space among the large-scale space; segmenting, by using the RGB-D data and the camera pose data, the specific space into a plurality of segments, and generating a three-dimensional global segmentation map including the plurality of segmented segments; extracting, from the three-dimensional global segmentation map, point clouds of respective ones of the plurality of segments and spatial attribute information of respective ones of the plurality of segments; inputting the extracted point clouds and the spatial attribute information to an encoder; acquiring, from the encoder, node features for respective ones of the plurality of segments and edge features representing relationships among the plurality of segments; inputting the node features and the edge features to graph neural networks; acquiring, from the graph neural networks, a local three-dimensional semantic scene graph including nodes corresponding to the node features and edges corresponding to the edge features; and merging, through graph fusion, the local three-dimensional semantic scene graph into a three-dimensional semantic scene graph stored in pre-specified storage.

Further, the encoder may comprise at least one of a node encoder that processes the point clouds and the spatial attribute information of respective ones of the plurality of segments, and an edge encoder that processes the spatial attribute information of adjacent-segment pairs among the plurality of segments.

Further, the inputting to the encoder may comprise: inputting the point clouds and the spatial attribute information of respective ones of the plurality of segments to the node encoder and inputting the spatial attribute information of the adjacent-segment pairs to the edge encoder, and the spatial attribute information may comprise at least one of center coordinates of the plurality of segments, and sizes and volumes of bounding boxes including the plurality of segments.

Further, the node encoder may comprise a point encoder that processes the point clouds of respective ones of the plurality of segments, and the acquiring of the node features may comprise: generating latent feature vectors for respective ones of the plurality of segments by processing the point clouds of respective ones of the plurality of segments in the point encoder; extracting the node features for respective ones of the plurality of segments by processing the latent feature vectors and the spatial attribute information in the node encoder; and acquiring the node features extracted from the node encoder.

Further, the acquiring of the edge features may comprise: extracting the edge features representing relationships between the adjacent segments by processing the spatial attribute information between the adjacent segments in the edge encoder; and acquiring the edge features extracted from the edge encoder.

Further, the acquiring of the local three-dimensional semantic scene graph may comprise updating the node features and the edge features, respectively, in a message passing layer of the graph neural networks generating, in the graph neural networks, the local three-dimensional semantic scene graph by using the updated node features and the updated edge features through the updating and acquiring the local three-dimensional semantic scene graph generated from the graph neural networks, and the local three-dimensional semantic scene graph may comprise nodes corresponding to the updated node features and edges corresponding to the updated edge features.

Further, the method may further comprise: extracting a descriptor of the specific space by using the updated node features and the updated edge features; and comparing similarity between the extracted descriptor of the specific space and descriptors of the large-scale space stored in the pre-specified storage, and the extracting of the descriptor of the specific space may comprise: generating a first embedding vector for the updated node features and a second embedding vector for the updated edge features by embedding the updated node features and the updated edge features; inputting the first embedding vector and the second embedding vector to a Vector of Locally Aggregated Descriptors (VLAD) module; and extracting the descriptor of the specific space by processing the first embedding vector and the second embedding vector in the VLAD module.

Further, as a result of the similarity comparison, in a case where a specific descriptor satisfying a preset threshold exists among the descriptors of the large-scale space stored in the pre-specified storage, the specific descriptor may be stored by replacing the descriptor of the specific space, and, through the graph fusion, the local three-dimensional semantic scene graph may be merged into the three-dimensional semantic scene graph stored in the pre-specified storage, and as the result of the similarity comparison, in a case where the specific descriptor satisfying the preset threshold does not exist among the descriptors of the large-scale space stored in the pre-specified storage, the descriptor of the specific space and the local three-dimensional semantic scene graph may be stored in the pre-specified storage, and, through the graph fusion, the local three-dimensional semantic scene graph may be updated into the three-dimensional semantic scene graph stored in the pre-specified storage, and the specific descriptor may be existing data stored in the pre-specified storage in correspondence to the specific space.

Meanwhile, there is provided a system for generating a three-dimensional scene graph using a plurality of agents, according to the present invention. The system may: acquire, from at least one agent among the plurality of agents, RGB-D data and camera pose data for a specific space among the large-scale space; segment, by using the RGB-D data and the camera pose data, the specific space into a plurality of segments, and generating a three-dimensional global segmentation map including the plurality of segmented segments; extract, from the three-dimensional global segmentation map, point clouds of respective ones of the plurality of segments and spatial attribute information of respective ones of the plurality of segments; input the extracted point clouds and the spatial attribute information to an encoder; acquire, from the encoder, node features for respective ones of the plurality of segments and edge features representing relationships among the plurality of segments; input the node features and the edge features to graph neural networks; acquire, from the graph neural networks, a local three-dimensional semantic scene graph including nodes corresponding to the node features and edges corresponding to the edge features and merge, through graph fusion, the local three-dimensional semantic scene graph into a three-dimensional semantic scene graph stored in pre-specified storage.

Meanwhile, there is provided a program capable of being stored on a computer-readable recording medium that is executed by one or more processes in an electronic device, according to the present invention. The program may comprise instructions for performing: acquiring, from at least one agent among the plurality of agents, RGB-D data and camera pose data for a specific space among the large-scale space; segmenting, by using the RGB-D data and the camera pose data, the specific space into a plurality of segments, and generating a three-dimensional global segmentation map including the plurality of segmented segments; extracting, from the three-dimensional global segmentation map, point clouds of respective ones of the plurality of segments and spatial attribute information of respective ones of the plurality of segments; inputting the extracted point clouds and the spatial attribute information to an encoder; acquiring, from the encoder, node features for respective ones of the plurality of segments and edge features representing relationships among the plurality of segments; inputting the node features and the edge features to graph neural networks; acquiring, from the graph neural networks, a local three-dimensional semantic scene graph including nodes corresponding to the node features and edges corresponding to the edge features; and merging, through graph fusion, the local three-dimensional semantic scene graph into a three-dimensional semantic scene graph stored in pre-specified storage.

As described above, according to the method and system for generating a three-dimensional scene graph using multiple agents according to the present invention, by multiple agents cooperating with each other to explore quickly in real time large-scale spaces, a hierarchical three-dimensional scene graph for large-scale spaces may be generated (or constructed) quickly and efficiently.

Also, according to the method and system for generating a three-dimensional scene graph using multiple agents according to the present invention, multiple agents may simultaneously explore different spaces (or zones) within a large-scale space, and may collect and share data for different spaces. Through this, in the present invention, large-scale spaces may be analyzed quickly, and a three-dimensional scene graph for large-scale spaces may be generated.

Further, according to the method and system for generating a three-dimensional scene graph using multiple agents according to the present invention, by using multiple agents, data for large-scale spaces may be collected, and object and relationship information within a large-scale space may be stored hierarchically in a database. Through this, in the present invention, a three-dimensional scene graph for large-scale environments may be generated efficiently, and through the constructed database, an environment capable of effectively understanding and integrally managing large-scale spaces may be provided.

In addition, according to the method and system for generating a three-dimensional scene graph using multiple agents according to the present invention, by storing in the database the data for spaces that multiple agents respectively have explored, even if multiple agents visit the same space multiple times, the data may be managed efficiently. Through this, in the present invention, information acquired by each agent is not duplicated, and is accurately merged and may be reflected in a final three-dimensional scene graph.

That is, the method and system for generating a three-dimensional scene graph using multiple agents according to the present invention stores, in the database, data for large-scale spaces collected (or acquired) by using multiple agents, and may generate and update in real time a three-dimensional scene graph for large-scale spaces. The present invention may be utilized in various application fields such as security and surveillance systems, a robotics field, augmented reality (AR) and virtual reality (VR).

### BRIEF DESCRIPTION OF THE DRAWINGS

FIG. 1 is a conceptual diagram for describing a three-dimensional scene graph generation system using multiple agents according to the present invention;

FIG. 2 is a conceptual diagram for describing a three-dimensional scene graph update algorithm according to the present invention;

FIG. 3 is a flowchart for describing a method for generating a three-dimensional scene graph using multiple agents according to the present invention;

FIGS. 4, 5, 6, 7, 8, and 9 are conceptual diagrams for describing a method for generating a three-dimensional scene graph using multiple agents according to the present invention; and

FIGS. 10 and 11 are tables and graphs showing one embodiment of the training results of a three-dimensional scene graph generation model trained by a method for generating a three-dimensional scene graph using multiple agents according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including”, “having”, and the like are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a method and system for generating a three-dimensional scene graph using multiple agents. The three-dimensional scene graph generation system according to the present invention may also be referred to as “multiple agents system.” The three-dimensional scene graph generation system according to the present invention may be a system that, by using multiple (or plural) agents, may explore large-scale spaces, and generate in real time a three-dimensional scene graph for large-scale spaces.

An “agent” described in the present invention may mean an independent subject configured to collect and process data (or information) within a specific space, and to perform a role of reconstructing a specific space. Such an agent may include at least one among robots, drones, cameras (mobile cameras, fixed cameras, etc.), mobile devices (for example, smartphones, tablets, etc.), wearable devices, and autonomous vehicles. For example, a plurality of robots that simultaneously explore different spaces located within a large-scale space (or indoor space, outdoor space, etc.) may become agents, and respective robots may collect and analyze information about spaces explored (or visited) to generate three-dimensional data. In this specification, for convenience of description, explanation is to be made on the premise that the agent is “a robot.”

In this case, the agent may, by using various devices such as an RGB-D camera (or sensor), a Light Detection and Ranging (LiDAR) sensor, a stereo camera, a Time-of-Flight (ToF) camera, etc., explore a specific space (for example, indoor or outdoor, etc.), and may collect at least one of RGB-D data (or frames, sequences, etc.) and camera pose data for the explored space. For example, in a case where the agent is “a robot,” an RGB-D camera configured to collect three-dimensional data for a space to be explored may be included (or mounted) to exist in the robot.

RGB-D data (or information) may be employed (or used, utilized, etc.) as input data for reconstructing a three-dimensional scene and for identifying relationships between a specific object and another object. RGB-D data includes, for each frame, an RGB image (or, a color image, color information, etc.) and depth information, and through this, color and distance information of each pixel (or shape, color, depth (or distance), etc. of an object in a scene) may be identified. Based on such RGB-D data, three-dimensional point cloud (or three-dimensional point-cloud data) data for a specific object in a scene and for a surrounding environment of the corresponding object may be generated.

Camera pose data (or information) indicates a position and a direction of a camera at a point in time when RGB-D data is captured, and may be employed (or utilized, used, etc.) to align spatial relationships among a plurality of frames and to reconstruct a three-dimensional scene. A camera position is generally expressed by three-dimensional coordinates, and a direction may be represented by a quaternion or a rotation matrix. Camera pose data, by appropriately mapping each frame in a three-dimensional space, maintains spatial continuity among a plurality of frames and makes possible accurate three-dimensional reconstruction (for example, three-dimensional scene reconstruction). For example, the three-dimensional scene graph generation system (or an agent) according to the present invention may, through position and direction information of a camera included in camera pose information, accurately identify positional relationships among frames. Through this, data of each frame is mapped to an appropriate position in a three-dimensional space, and accurate three-dimensional reconstruction work may be possible.

Also, camera pose data may be utilized to determine positions and directions of respective segments (that is, object nodes) within a three-dimensional global segmentation map (3D GSM) and within a reconstructed scene. Through this, positions of respective objects may be expressed accurately within a real scene.

Reconstruction of a three-dimensional scene is performed independently at each agent, and each agent collects RGB-D frames and camera pose information in real time, and may reconstruct a scene from respective positions and viewpoints.

That is, a plurality of agents generate three-dimensional global segmentation maps for spaces respectively explored (or visited), and integrate this in the three-dimensional scene graph generation system, and may finally generate an integrated three-dimensional scene graph.

Meanwhile, at least a part of processes and data processing performed in a method and system for generating a three-dimensional scene graph according to the present invention (for example, three-dimensional reconstruction, three-dimensional global segmentation map generation, data storage for spaces explored, utilization and update of stored data, etc.) may be performed by an agent.

However, in this specification, for convenience of description, without separately distinguishing the above-described cases, a subject that performs processes and data processing according to the present invention is to be referred to as and described as “three-dimensional scene graph generation system” or “three-dimensional scene graph generation model.”

Meanwhile, the three-dimensional scene graph generation system according to the present invention may include a plurality of agents. The three-dimensional scene graph generation system according to the present invention may, by combining data generated by a plurality of agents respectively exploring different spaces, generate a single overall three-dimensional scene graph. In a three-dimensional scene graph, a node represents a thing (or object), and an edge may represent a relationship between things (or objects).

In one embodiment, a plurality of agents included in the three-dimensional scene graph generation system according to the present invention may, by cooperating with each other, quickly collect information for a plurality of spaces. In this case, the three-dimensional scene graph generation system may efficiently integrate various information collected from the plurality of agents, and various information collected from the plurality of agents may be stored in a storage unit (or a pre-specified storage).

Meanwhile, the three-dimensional scene graph generation system according to the present invention includes a three-dimensional scene graph generation model, and particularly, the present invention aims to generate in real time a three-dimensional scene graph for large-scale spaces that multiple agents, by cooperating with each other (or simultaneously), have explored.

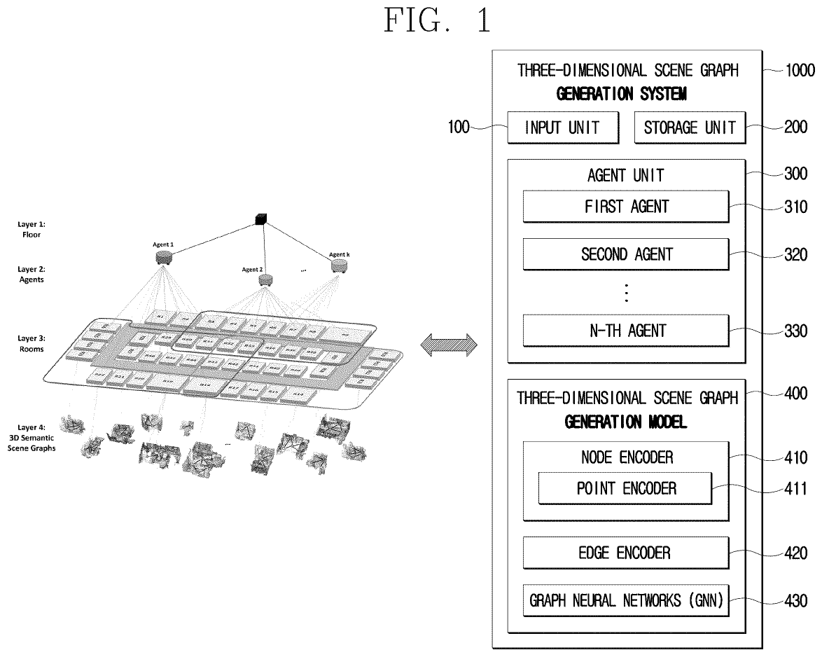

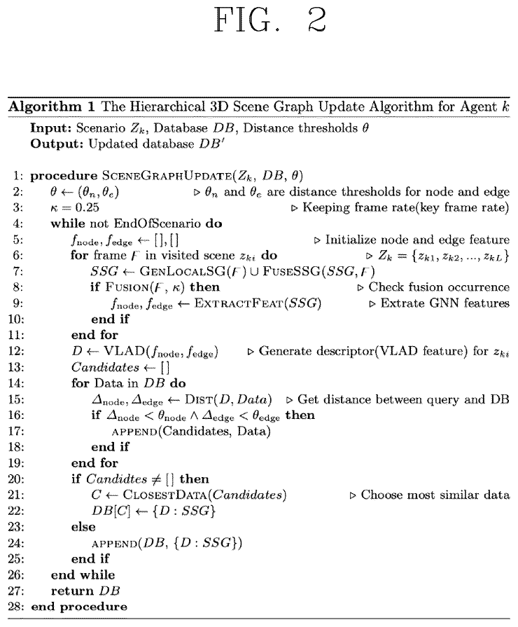

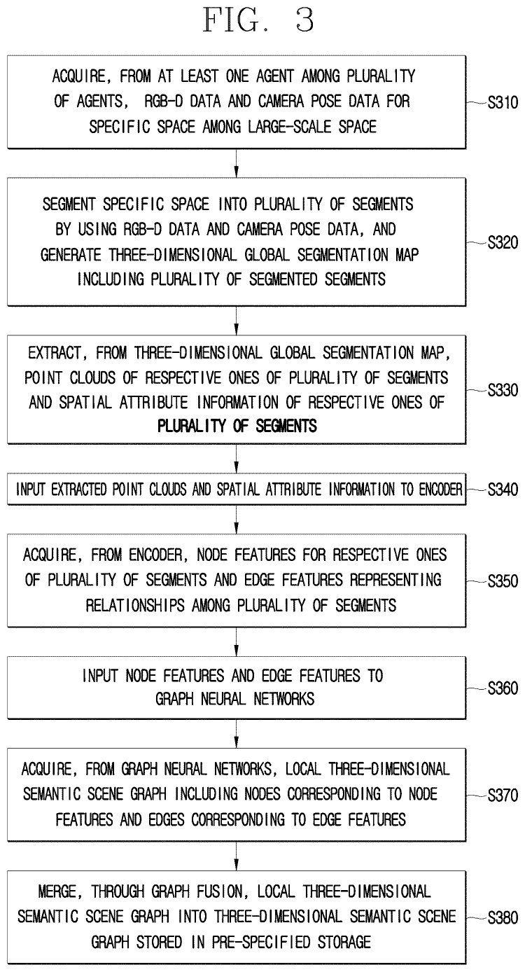

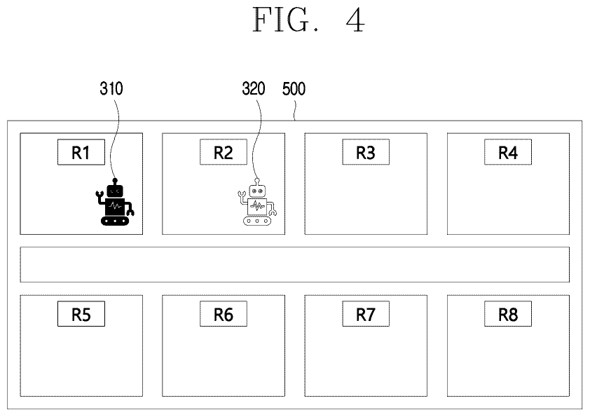

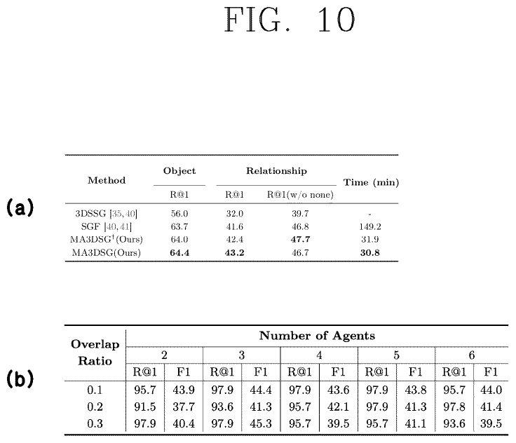

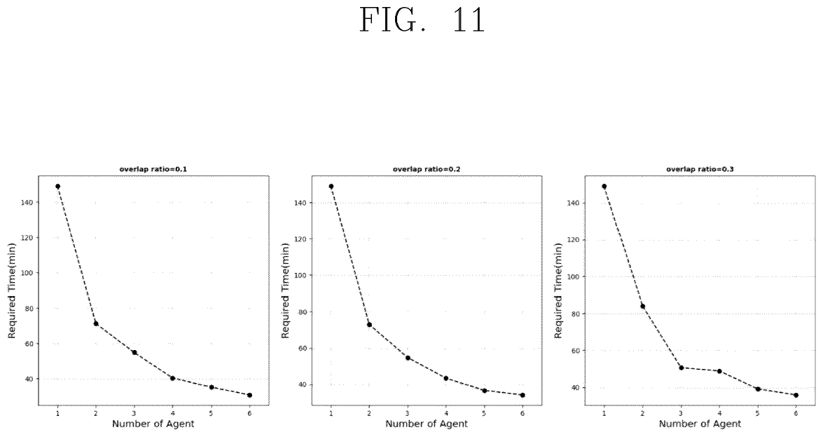

Hereinafter, the present invention will be described in more detail with reference to the accompanying drawings. FIG. 1 is a conceptual diagram for describing a three-dimensional scene graph generation system using multiple agents according to the present invention. FIG. 2 is a conceptual diagram for describing a three-dimensional scene graph update algorithm according to the present invention. FIG. 3 is a flowchart for describing a method for generating a three-dimensional scene graph using multiple agents according to the present invention, and FIGS. 4, 5, 6, 7, 8, and 9 are conceptual diagrams for describing a method for generating a three-dimensional scene graph using multiple agents according to the present invention. Further, FIGS. 10 and 11 are tables and graphs showing one embodiment of the training results of a three-dimensional scene graph generation model trained by a method for generating a three-dimensional scene graph using multiple agents according to the present invention.

Meanwhile, as illustrated in FIG. 1, a three-dimensional scene graph generation system 1000 according to the present invention may include at least one of an input unit 100, a storage unit 200, an agent unit 300, and a three-dimensional scene graph generation model 400.

Although not illustrated, the three-dimensional scene graph generation system 1000 may include one or more processors, and such processors may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), etc.). The one or more processors may be configured to execute instructions, computer-readable directives, and/or other commands described in the present specification stored (or included) in the storage unit 200. The method and system for generating a three-dimensional scene graph generation according to the present invention may perform data processing described below by a memory and at least one processor cooperating. The processor, by using data and information stored in the memory, may perform a series of operations and data processing. In this case, the memory may be a configuration of the storage unit 200.

Meanwhile, the input unit 100, as a means of data input, may be constituted in various kinds. For example, the input unit 100 may be configured to receive user input. The input unit 100 may be configured to receive user input from a user terminal. Here, “receiving input” may mean receiving an input signal (or a selection signal) corresponding to the user input, based on input being made by a user through an input-unit configuration provided to a user terminal. In the present invention, the input unit 100 does not necessarily mean a hardware means, and may be understood as a passage for receiving input from a user.

The input unit 100 may also be referred to as a user interface module. The input unit 100 may include a touch screen, a computer mouse, a keyboard, a keypad, a touch pad, a trackball, a joystick, a voice recognition module, or other similar devices. However, in the present invention, a limitation is not placed on types of the input unit 100.

Here, the user input may include a document, text, an image (or a video), voice, and the like. In this case, the three-dimensional scene graph generation system 1000 may further include a module that converts voice into text.

Next, the storage unit 200 serves to store various data related to the present invention, and may include one or more non-transitory computer-readable storage media that may be read and/or accessed by at least one of one or more processors.

The one or more computer-readable storage media may include volatile and/or non-volatile storage constituent elements such as optical, magnetic, organic, or other memory or disk storage devices. In some examples, the storage unit 200 may be implemented using a single physical device (for example, one optical, magnetic, organic, or other memory or disk storage device), whereas in other examples, the storage unit 200 may be implemented using two or more physical devices.

The storage unit 200 may include computer-readable directives and additional data. The storage unit 200 may include storage necessary to perform at least a part of methods, scenarios, and techniques described in the present specification and/or at least a part of functions of devices and a network.

Further, at least a part of the storage unit 200 may be cloud storage or a cloud server. In the storage unit 200, at least a part of data corresponding to user input received from the input unit 100 and training data may be stored.

That is, the storage unit 200 is sufficient as a space in which information necessary for operation of the three-dimensional scene graph generation system 1000 according to the present invention is stored, and may be understood as not having a constraint on a physical space.

Meanwhile, the storage unit 200 may include pre-specified storage in which information related to a plurality of agents 310, 320, and 330 is stored hierarchically. The pre-specified storage may be configured to include at least one of a first layer, a second layer, a third layer, and a fourth layer.

First, in the first layer (e.g., Layer 1, or a first tier), information about a space (or a zone, a region, a floor, a place, etc.) in which the plurality of agents 310, 320, and 330 operate (or act) may be stored. For example, the plurality of agents 310, 320, and 330, by respectively taking charge of individually assigned spaces, may quickly explore a large-scale space. That is, the plurality of agents 310, 320, and 330, by simultaneously exploring spaces respectively assigned, may shorten time required for large-scale space exploration. Information about spaces that such a plurality of agents 310, 320, and 330 respectively take charge of (or explore) may be stored.

Also, in the second layer (ex: Layer 2, or a second tier), state information of the plurality of agents 310, 320, and 330 and information about spaces explored (or visited) may be stored. For example, in a case where a specific agent explores a specific space and collects data of the specific space, in the second layer, a position of the specific space and related data may be stored. Through this, in the present invention, in a case where agents different from the specific agent need to visit the specific space, other agents are enabled to utilize information collected by the specific agent.

Subsequently, in the third layer (ex: Layer 3, or a third tier), descriptors for point clouds of spaces explored by respective agents and for place recognition (or space recognition) may be stored. A point cloud represents a three-dimensional shape of a space, and may include important data for identifying positions and relationships of respective things. In addition, a descriptor includes unique features capable of recognizing a specific space, and, when an agent revisits the same space or when information sharing with another agent is needed, may be used usefully.

Further, in the fourth layer (ex: Layer 4, or a fourth tier), a three-dimensional semantic scene graph (3D semantic scene graph, or three-dimensional scene graph) generated for spaces respectively explored by the plurality of agents 310, 320, and 330 may be stored. A three-dimensional semantic scene graph visually expresses relationships and structures among things, and may represent positions and mutual relationships of chairs, tables, walls, etc. existing in a space. Such a three-dimensional semantic scene graph is essential for understanding configurations and contexts of respective spaces, and, based thereon, agents or other systems may understand an environment and may respond appropriately.

As described above, the three-dimensional scene graph generation system 1000 may, by using the plurality of agents 310, 320, and 330, collect data for a large-scale space, and may store, hierarchically, object and relationship information within a large-scale space in pre-specified storage. Also, the three-dimensional scene graph generation system 1000, by storing in pre-specified storage data for spaces respectively explored by the plurality of agents 310, 320, and 330, enables data to be managed efficiently even if the plurality of agents 310, 320, and 330 visit the same space multiple times. In the present invention, pre-specified storage in which such information is stored is referred to as “database (DB)”, and, in this case, the pre-specified storage (or the database) may be a configuration of the storage unit 200.

Next, the agent unit 300 may include the plurality of agents 310, 320, and 330 that, by cooperating with each other, explore a large-scale space. In one embodiment, respective agents, according to received commands (or scenarios), may respectively explore a large-scale space, and may collect RGB-D data and camera pose data for respective spaces. Further, the three-dimensional scene graph generation system 1000, by using RGB-D data and camera pose data for respective spaces, may progressively generate local three-dimensional semantic scene graphs (Local 3D Scene Graphs) for respective spaces. The local three-dimensional scene graphs for respective spaces may be integrated (or merged) into a three-dimensional semantic scene graph (3D Semantic Scene Graph) through a parallel graph fusion mechanism. Thereafter, the three-dimensional semantic scene graph may be integrated (or updated) into a hierarchical three-dimensional scene graph (Hierarchical 3D Scene Graph).

Here, a local three-dimensional semantic scene graph may be a smallest-unit graph that describes detailed regions of a room or a space. It is generated by collecting object information through frames in each scene that an agent explores, and, based thereon, a small region of the corresponding scene may be understood.

Also, a three-dimensional semantic scene graph may be a graph including detailed information about a specific space (for example, a room, a zone, etc.). A three-dimensional semantic scene graph is positioned at an end of a hierarchical three-dimensional scene graph (a process before generating a hierarchical three-dimensional scene graph), and may specifically describe, or visually express, objects within a specific space and relationships between objects.

Further, a hierarchical three-dimensional scene graph, as a final result of the three-dimensional scene graph generation system 1000 according to the present invention, may include information for all spaces explored by using the plurality of agents 310, 320, and 330. For example, a hierarchical three-dimensional scene graph is used to understand an entire structure of a building or a wide space, and the three-dimensional scene graph generation system 1000 may integrate positions of each agent and detailed information collected by the corresponding agent. This, because a hierarchical structure is possessed, may manage each space as one large structure that, while being individual, is integrated into an entire environment.

Next, the three-dimensional scene graph generation model 400 may be configured to perform a role of generating in real time a three-dimensional scene graph for a large-scale space explored by the plurality of agents 310, 320, and 330 cooperating with each other.

In this case, the three-dimensional scene graph generation model 400 according to the present invention may be a model trained through two stages of training processes. First, in a first stage, the three-dimensional scene graph generation system 1000 may train the three-dimensional scene graph generation model 400 in an end-to-end manner in order to generate a three-dimensional semantic scene graph for each agent. Next, in a second stage, the three-dimensional scene graph generation system 1000 trains a Vector of Locally Aggregated Descriptors (VLAD) module (or layer) included in the three-dimensional scene graph generation model 400 to perform a space (or place) recognition task. Such a two-stage training method may enable the three-dimensional scene graph generation model 400 to generate an accurate semantic scene graph and to perform efficient space recognition.

Meanwhile, the three-dimensional scene graph generation model 400 may generate a three-dimensional global segmentation map by performing progressive geometric segmentation for RGB-D data collected by each agent. Here, a three-dimensional global segmentation map is composed of a plurality of segments (S={S₁, S₂, . . . , Sₙ}), and each segment may include a three-dimensional point cloud (Pᵢ={Pᵢ|∈ [symbol] ³}). Whenever a new frame is input, a three-dimensional global segmentation map may be updated by integrating new segments or removing old segments. Also, the three-dimensional scene graph generation model 400 may calculate various properties (or spatial attribute information) for segments (Sᵢ). Here, various properties may include at least one among a center coordinate (or position information, p̅₁∈ [symbol] ³) of each segment, a standard deviation (or distribution vᵢ) of points constituting each segment, a respective size (bᵢ=(bₓ, b_{y}, b_{z})∈ [symbol] ³) of a bounding box including each segment, a three-dimensional volume (vᵢ=bₓ·b_{y}·b_{z}∈ [symbol] ) of each segment calculated based on the respective size of the bounding box, a maximum length of the bounding box (or a maximum value among all edges of the bounding box, lᵢ=max{bₓ, b_{y}, bₙ}∈ [symbol] ).

Such a three-dimensional scene graph generation model 400 may include a node encoder 410 and an edge encoder 420. The node encoder 410 may generate a node feature by connecting features of each segment with a spatial attribute of the corresponding segment. Thereafter, the three-dimensional scene graph generation model 400, by using relative spatial attribute information extracted through a Multi-Layer Perceptron (MLP), may select a neighboring-segment set and may generate an edge feature. In the present invention, to configure a point encoder (E(·), 411) in the node encoder 410, Kernel Point Convolution (KPConv)(Eₖ(·)) is used, converting a point cloud (Pᵢ) into a latent feature vector and extracting basic spatial information. The KPConv extracts a local geometric structure of a three-dimensional point cloud more effectively than a general PointNet, and, by applying a flexible convolution to irregular point-cloud data, may adaptively match density changes of the point cloud.

In the present invention, after extracting a latent feature vector from a point cloud, to solve scale invariance generated by normalizing an input point to a unit sphere, a space-invariant attribute may be connected to E(Pᵢ). Therefore, in the present invention, an input of the node encoder 410 may be defined as [Equation 1] below.

$${v}_{i} = [ E ( {P}_{i} ) , {σ}_{i} , ln ( {b}_{i} ) , ln ( {v}_{i} ) , ln ( {l}_{i} ) ] \qquad [ Equation l ]$$

Here, fₛ may mean a concatenation function. In the present invention, a plurality of (two) kernel point convolution layers may be used to configure the node encoder 410.

In contrast, the edge encoder 420 may be configured with a plurality of (three) multi-layer perceptrons (MLPs). The edge encoder 420, for any two neighboring nodes i and j (i≠j), may extract an edge feature by using a pair of spatial attribute information as in [Equation 2] below.

$${ϕ}_{i j} = [ {\overline{p}}_{i} - {\overline{p}}_{j} , {σ}_{i} - {σ}_{j} , {b}_{i} - {b}_{j} , ln ( \frac{{v}_{i}}{{v}_{j}} ) , ln ( \frac{{l}_{i}}{{l}_{j}} ) ] \\ {e}_{i j} = {f}_{s} ( {ϕ}_{i j} ) \qquad [ Equation 2 ]$$

Here, fₛ may mean a multi-layer perceptron (MLP) that projects a spatial attribute into a latent space.

Further, the three-dimensional scene graph generation model 400 may include Graph Neural Networks (GNNs) 430. The graph neural networks 430 according to the present invention may include a Feature-wise Attention (FAT) module to enhance node features and edge features. The FAT module takes a query (or inquiry, Q∈ [symbol] ^{dq}) and a target (or objective, T∈ [symbol] ^{d}^{ₜ}) as inputs, and may calculate a weight distribution of the same dimension as the target (T) by using a multi-layer perceptron (MLP). This may be expressed as in [Equation 3] below.

$$FAT ( Q , T ) = softmax ( {f}_{w} ( Q ) ) ⊙ T \qquad [ Equation 3 ]$$

Here, f_{w} means a multi-layer perceptron that distributes weights, ⊙ and may mean an element-wise multiplication. In addition, in the present invention, for a more flexible attention distribution, by using multi-head attention, Q={q₁, q₂, . . . , qₕ} and T={t₁, t₂, . . . tₕ} are divided, and h may mean the number of heads. Further, in the present invention, by using a Feature-wise Attention Network (FAN), a weight message may be calculated as in [Equation 4] below.

$$MH - FAT ( Q , T ) = {[ FAT ( {q}_{i} , {t}_{i} ) ]}_{i = 1}^{h} , \\ FAN ( {v}_{i} , {e}_{i j} , {v}_{j} ) = MH - FAT ( [ {\tilde{f}}_{q} ( {v}_{i} ) , {\tilde{f}}_{e} ( {e}_{i j} ) ] , {\tilde{f}}_{t} ( {v}_{j} ) ) \qquad [ Equation 4 ]$$

Here, \hat{f}_{q}, \hat{f}ₑ, \hat{f}ₜ respectively may mean a single-layer perceptron that maps vᵢ, eᵢⱼ, vⱼ into a d_{q}/2,d_{q}/2,dₜ-dimensional space. Finally, in the present invention, the graph neural networks 430 is used, together with a Message Passing Layer, may update node and edge features by integrating information from neighbors. In each message passing layer ( [symbol] ), the graph neural networks 430, by using [Equation 5] below, may respectively update a node feature

$$( {v}_{j}^{m} )$$

and an edge feature

$$( {e}_{i j}^{m} ) .$$

$${v}_{i}^{m + 1} = {f}_{v} ( {v}_{i}^{m} , {max}_{j ∈ 𝒩 ( i )} ( FAN ( {v}_{i}^{m} , {e}_{i j}^{m} , {v}_{j}^{m} ) ) ) \\ {e}_{i j}^{m + 1} = {f}_{e} ( {v}_{i}^{m} , {e}_{i j}^{m} , {v}_{j}^{m} ) \qquad [ Equation 5 ]$$

Here, fᵥ and fₑ mean multi-layer perceptrons, and N(i) may mean a neighbor set of a node (i).

The three-dimensional scene graph generation model 400, through Graph Fusion, by progressively merging a local three-dimensional scene graph generated in a previous frame, may generate an integrated three-dimensional semantic scene graph for a space that an agent has explored. In the present invention, to prevent potential inconsistencies that may occur because multiple predictions occur for semantics of each segment and each edge, a moving-average approach method may be used. The three-dimensional scene graph generation model 400 may store a weight (wₛ) for class prediction at each segment and a probability (μ) for predicate prediction at each edge. In this case, at time, t

$${w}_{s}^{t} and {u}^{t}$$

may be updated as in [Equation 6] below.

$${μ}^{t} = \frac{{w}_{s}^{t - 1} \cdot {μ}^{t - 1} + {w}_{s}^{t} \cdot {μ}^{t}}{{w}_{s}^{t - 1} + {w}_{s}^{t}} \\ {w}_{s}^{t} = min ( {w}^{′} , {w}_{s}^{t - 1} + {w}_{s}^{t} ) \qquad [ Equation 6 ]$$

Here, w′ may mean a possible maximum weight value.

After data processing of the graph neural networks 430, two multi-layer perceptron classifiers may predict node classes and edge predicates. In the present invention, a composite cross-entropy loss may be used for both an object (L_{Obj}) and a predicate (L_{pred}). Since an object pair may have multiple valid relationships, a class-wise binary cross-entropy may be applied for a predicate (L_{pred}). A loss function of the three-dimensional scene graph generation model 400 may be defined as in [Equation 7] below.

$${L}_{SSG} = {λ}_{obj} \cdot {L}_{obj} + {L}_{pred} \qquad [ Equation 7 ]$$

Here, λ_{Obj} may mean a weighting factor. The three-dimensional scene graph generation model 400 may perform training by using [Equation 7] above.

Meanwhile, an algorithm illustrated in FIG. 2 may mean an overall hierarchical three-dimensional scene graph update algorithm for an agent (k) Such an algorithm may include i) descriptor extraction for space (or place) recognition and ii) a matching algorithm. In the present invention, the algorithm may also be referred to as “a preset algorithm” or “a preset hierarchical three-dimensional scene graph update algorithm.”

When a specific agent discovers a space previously visited by another agent, a need exists to update existing nodes and edges stored in a database. Conversely, when, from another agent, the corresponding space has not been explored, information of the un-explored space needs to be able to be added as new data. To this end, in the present invention, each agent is enabled to perform a space recognition process based on sequential features (or successive features).

The three-dimensional scene graph generation system 1000, by using the graph neural networks 430, may generate (or extract) descriptors (or describers) including both a global context and local contexts. A scene for each space is composed of L frames, and, in each frame, for nodes and edges respectively, N_{f}×Dₙ and E_{f}×Dₑ dimensional GNN features may be extracted. Here, N_{f} and E_{f} mean numbers of features (or characteristics), and Dₙ and Dₑ may mean dimensions. However, since extracting features in all frames requires excessive computational (or operation) resources and may affect data quality of descriptors, in the present invention, GNN features may be extracted only in frames in which graph fusion occurs. To process this in real time, in the present invention, by selecting only a part (for example, 25%) of frames in which graph fusion occurs, an embedding vector (a first embedding vector) for node features and an embedding vector (a second embedding vector) for edge features may be extracted (or, GNN node and edge features are extracted). A frame rate (k) used in this process may be determined based on a preset criterion (for example, based on selected frames).

That is, in the present invention, node features (the first embedding vector) of size Lₖ×N_{f}×Dₙ and edge features (the second embedding vector) of size Lₖ×E_{f}×Dₑ may be used as inputs of a VLAD module. N_{f} and E_{f} may vary depending on numbers of nodes (vᵢ) and edges (e_{U}) visible in a frame. Since, in the present invention, a goal is to generate (or extract) a fixed-length descriptor expressing a scene by utilizing NetVLAD, from varying input features, descriptors of nodes and edges of sizes K×Dₙ and K×Dₑ, respectively, may be extracted. Here, K may mean the number of clusters.

In the present invention, in a case of a descriptor (D=v, ε), v and ε respectively mean vertices and edges, and elements of v and ε may be calculated by using [Equation 8] below.

$$v ( k ) = {\sum }_{f = 1}^{{L}_{k}} {\sum }_{i = 1}^{{N}_{f}} {\overline{α}}_{k} ( {x}_{f i} ) \cdot ( {x}_{f i} - {c}_{k} ) \\ {ε}_{k} = {\sum }_{f = 1}^{{L}_{k}} {\sum }_{i = 1}^{{E}_{f}} {\overline{β}}_{k} ( {x}_{f i} ) \cdot ( {x}_{f i} - {c}_{k}^{′} ) \qquad [ Equation 8 ]$$

Here, x_{fi} means an individual feature or embedding, and cₖ and

$${c}_{k}^{′}$$

mean a k-th center of clusters, and α̅ₖ and β̅ₖ, as in [Equation 9] below, may mean a characterized soft assignment.

$${\overline{α}}_{k} ( {x}_{f i} ) = \frac{{e}^{{w}_{k}^{T} {x}_{f i} + {b}_{k}}}{{\sum }_{{k}^{′} = 1}^{K} {e}^{{w}_{{k}^{′}}^{T} {x}_{f i} + {b}_{{k}^{′}}}} \\ {\overline{β}}_{k} ( {x}_{f i} ) = \frac{{e}^{{{w}^{′}}_{k}^{T} {x}_{f i} + {b}_{k}^{′}}}{{\sum }_{{k}^{′} = 1}^{K} {e}^{{{w}^{′}}_{{k}^{′}}^{T} {x}_{f i} + {b}_{{k}^{′}}^{′}}} \\ Here , {w}_{k} , {w}_{k}^{′} , {b}_{k} , {b}_{k}^{′} , {c}_{k} , and {c}_{k}^{′} \qquad [ Equation 9 ]$$

may be a set of learnable parameters for a k-th cluster.

Meanwhile, the three-dimensional scene graph generation model 400 (or an agent) may use a descriptor representing a space explored by an agent as a query of a matching algorithm. The three-dimensional scene graph generation model 400, by calculating a Euclidean distance with descriptors stored in a database, may identify the same space when a node distance (Δ_{node}) and an edge distance (Δ_{edge}) are smaller than respective thresholds (or preset thresholds). Thereafter, the three-dimensional scene graph generation model 400 may update a space corresponding to the query and a three-dimensional semantic scene graph to a newly generated graph.

Again, in the above-described second stage of a training process, the three-dimensional scene graph generation system 1000 may freeze (i.e., fix, lock, hold or maintain) the weights of the three-dimensional scene graph generation model 400 that generates a three-dimensional semantic scene graph, and, for space recognition among agents, may train a VLAD module by using a Triplet Loss Function. The three-dimensional scene graph generation system 1000 may constitute each training tuples in a preprocessed dataset stored in the storage unit in a form of T=(D_{α}, Dₚ, {D_{neg}}). Here, D_{α} is an anchor descriptor, Dₚ is a positive descriptor generated in the same space (or place) as the anchor, and {D_{neg}} may mean a set of negative descriptors generated in a space different from the anchor. A triplet loss may be defined to minimize a distance (δₚₐₛ) between D_{α} and Dₚ, and to maximize a distance (δ_{neg}) between D_{α} and a negative descriptor (D_{neg,i}∈{D_{neg}}).

In particular, a loss function (lazy triplet loss) for training a VLAD module focuses on maximizing a distance between D_{α} and a closest (or similar) negative descriptor (D_{neg,i}). Such a loss function may be defined as in [Equation 10] below.

$${ℒ}_{lazy Trip} ( 𝒯 ) = {max}_{i} ( {[ α + {δ}_{pos} - {δ}_{neg , i} ]}_{+} ) \qquad [ Equation 10 ]$$

Here, [·]+ means a hinge loss function, and α may mean a constant defining a margin.

Meanwhile, the present invention is to provide a method and system for generating a three-dimensional scene graph using multiple agents that is capable of, by using multiple agents, exploring a large-scale space and generating in real time a three-dimensional scene graph for a large-scale space. In particular, the present invention may generate in real time three-dimensional scene graphs for spaces that respective agents have explored, and may integrate and update generated three-dimensional scene graphs. Accordingly, a method for generating a three-dimensional scene graph according to the present invention may be configured to include a process of generating a three-dimensional scene graph for a place visited by a specific agent, and a process of identifying whether the same place is visited among multiple agents, and updating a graph when necessary. Hereinafter, a method for generating a three-dimensional scene graph using multiple agents according to the present invention will be described more specifically.

First, in the present invention, from at least one agent among a plurality of agents, a process (S310, see FIG. 3) of acquiring RGB-D data and camera pose data for a specific space among a large-scale space and a process (S320, see FIG. 3) of segmenting the specific space into a plurality of segments by using RGB-D data and camera pose data, and generating a three-dimensional global segmentation map (3D Global Segmentation Map) including a plurality of segmented segments may proceed.

A large-scale space (or a large-scale indoor space, a large-scale outdoor space, etc.) may include a plurality of different spaces. For example, as illustrated in FIG. 4, a large-scale space 500 may include a first space R1, a second space R2, a third space R3, a fourth space R4, a fifth space R5, a sixth space R6, a seventh space R7, an eighth space R8, and the like. However, spaces included in the large-scale space 500 are not limited only to the mentioned examples, and various spaces in addition to the mentioned spaces may further be included.

The plurality of agents 310, 320, and 330 according to the present invention, by cooperating with each other, may explore in real time the large-scale space 500, and may collect data (or information) for the large-scale space 500. In this case, respective agents may be configured to either automatically perform exploration for a space in charge (or a space assigned to oneself), or to simultaneously explore the large-scale space 500 by control commands of the three-dimensional scene graph generation system 1000.

The three-dimensional scene graph generation system 1000, by the plurality of agents 310, 320, and 330 cooperating with each other, may control the plurality of agents 310, 320, and 330 to explore in real time the large-scale space 500. For example, the three-dimensional scene graph generation system 1000 may control the first agent 310 to explore the first space R1, and may control the second agent 320 to explore the second space R2. In this case, the first agent 310 and the second agent 320, respectively exploring the first space R1 and the second space R2 included in the large-scale space 500, may collect data (for example, three-dimensional data) for the first space R1 and the second space R2, respectively.

In this case, the three-dimensional scene graph generation system 1000, from a plurality of agents (the first agent 310 and the second agent 320), may acquire (or collect) simultaneously RGB-D data and camera pose data for each of the plurality of spaces (the first space R1 and the second space R2).

However, hereinafter, for convenience of description, a process of generating a three-dimensional scene graph for a specific space (for example, the first space R1) explored (or visited) by the first agent 310 will first be described with emphasis.

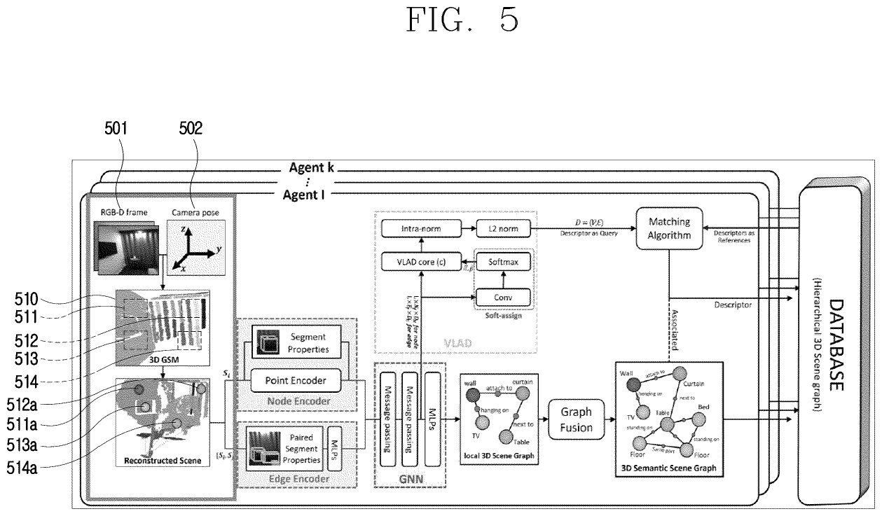

The three-dimensional scene graph generation system 1000 may acquire RGB-D data and camera pose data for a specific space among the large-scale space 500 from at least one agent. For example, as illustrated in FIG. 5, the three-dimensional scene graph generation system 1000 may acquire RGB-D data 501 and camera pose data 502 for the first space R1 from the first agent 310.

As described above, RGB-D data may be data including an RGB (colors of Red, Green, Blue, etc.) image and depth information. In addition, camera pose data indicates a position and a direction of a camera at a point in time when RGB-D data is captured (for example, where the camera is located and which direction is being captured), and may be data used to align spatial relationships among a plurality of frames and to reconstruct a three-dimensional scene.

Further, the three-dimensional scene graph generation system 1000, by processing RGB-D data 501 and camera pose data 502 for the first space R1 acquired from the first agent 310, may generate a three-dimensional global segmentation map 510 (or a first three-dimensional global segmentation map) for the first space R1.

The three-dimensional scene graph generation system 1000, by using an Incremental Geometric Segmentation algorithm, may process RGB-D data 501 for the first space R1. More specifically, the three-dimensional scene graph generation system 1000, by using incremental geometric segmentation, may segment the first space R1 into a plurality of segments 511, 512, 513, and 514 based on positions and shapes of objects (or things) for each frame, and may generate a three-dimensional global segmentation map (3D Global Segmentation Map) 510 including the plurality of segments 511, 512, 513, and 514.

That is, the three-dimensional global segmentation map 510 includes a plurality of segments (or zones) that structurally segment the first space R1, and respective segments of the plurality of segments may correspond to a specific object (or thing) or a space portion. For example, individual things such as a table, a chair, and a wall included in the first space R1 may be respectively segmented into segments.

Next, in the present invention, from a three-dimensional global segmentation map, a process of extracting point clouds of respective segments of the plurality of segments and spatial attribute information of respective segments of the plurality of segments may proceed (S330, see FIG. 3).

The three-dimensional scene graph generation system 1000 may extract point clouds (or three-dimensional point clouds) for the plurality of segmented segments 511, 512, 513, and 514.

More specifically, the three-dimensional scene graph generation system 1000 may extract point clouds for respective ones of the plurality of segments 511, 512, 513, and 514 included in the three-dimensional global segmentation map 510. For example, as illustrated in FIG. 5, the three-dimensional scene graph generation system 1000 may extract point clouds 511a, 512a, 513a, and 514a for respective ones of the plurality of segments 511, 512, 513, and 514 included in the three-dimensional global segmentation map 510.

A point cloud is data (or a set of three-dimensional coordinates) that expresses a surface of a thing (or object) as points, and may represent a structure of a space and a shape of a thing (or object). For example, in a case of a chair included in a space, a set of points constituting a surface of the chair may be expressed as a point cloud.

Further, the three-dimensional scene graph generation system 1000, based on the extracted point clouds 511a, 512a, 513a, and 514a, may calculate (or extract) various attributes for respective ones of the plurality of segments 511, 512, 513, and 514.

The three-dimensional scene graph generation system 1000, by using point clouds 511a, 512a, 513a, and 514a for respective ones of the plurality of segments 511, 512, 513, and 514, may extract spatial attribute information of respective ones of the plurality of segments 511, 512, 513, and 514. Here, spatial attribute information may include at least one of center coordinates (or position information) of respective ones of the plurality of segments 511, 512, 513, and 514, and size information and volume information of respective bounding boxes including respective ones of the plurality of segments 511, 512, 513, and 514.

In one embodiment, the three-dimensional scene graph generation system 1000, by calculating an average position of all points in respective point clouds 511a, 512a, 513a, and 514a of respective ones of the plurality of segments 511, 512, 513, and 514, may extract center coordinates of respective segments.

In another embodiment, the three-dimensional scene graph generation system 1000 detects bounding boxes including respective ones of the plurality of segments 511, 512, 513, and 514, and, by calculating sizes of respective detected bounding boxes, may extract size information of respective bounding boxes including respective segments. Size information of a bounding box may include width, length, and height values.

In another embodiment, the three-dimensional scene graph generation system 1000, based on sizes of respective extracted bounding boxes, may calculate a volume of a space occupied by respective segments (or things corresponding to segments). In this case, a calculation of volume may be calculated by using “width×length×height” included in bounding-box size information.

Meanwhile, in the present invention, extracted point clouds and spatial attribute information are input to an encoder (S340), and, from the encoder, a process of acquiring node features for respective ones of a plurality of segments and edge features representing relationships among the plurality of segments may proceed (S350, see FIG. 3).

The three-dimensional scene graph generation system 1000 may input extracted point clouds 511a, 512a, 513a, and 514a and spatial attribute information to an encoder of the three-dimensional scene graph generation model 400.

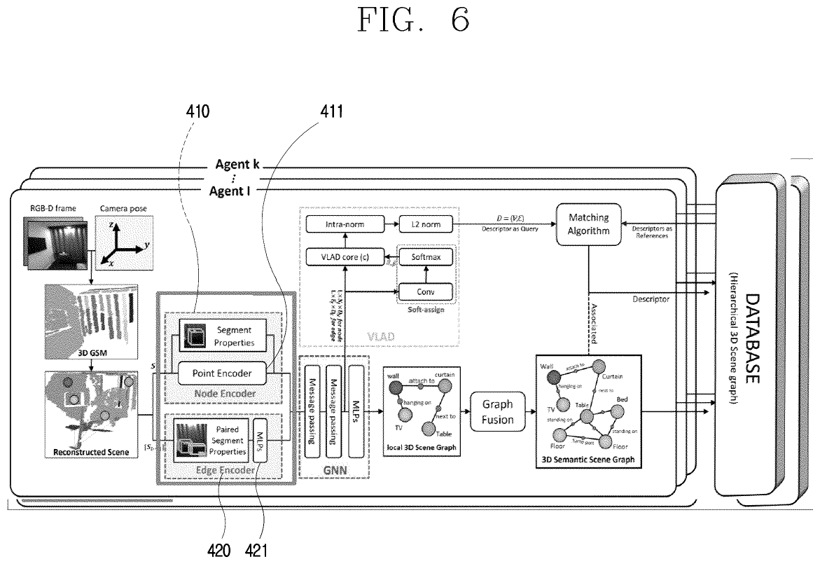

As illustrated in FIG. 6, the encoders 410 and 420 of the three-dimensional scene graph generation model 400 according to the present invention may include the node encoder 410 that processes point clouds 511a, 512a, 513a, and 514a of respective ones of the plurality of segments 511, 512, 513, and 514, and the edge encoder 420 that processes spatial attribute information of adjacent-segment pairs among the plurality of segments 511, 512, 513, and 514.

The three-dimensional scene graph generation system 1000 may input point clouds 511a, 512a, 513a, and 514a and spatial attribute information for respective ones of the plurality of segments 511, 512, 513, and 514 to the node encoder 410.

Here, the node encoder 410 may include a point encoder 411 composed of Kernel Point Convolution Layer (KPConv). The Kernel Point Convolution Layer of the point encoder 411, by receiving a point cloud as an input, learning density among points and geometric structures, etc. may generate (or extract) a latent feature vector (or latent feature). Such a Kernel Point Convolution Layer may efficiently process unstructured data, and may well reflect local characteristics among points. For example, the point encoder 411 composed of a Kernel Point Convolution Layer may extract a flat structure among surface points of a table and complex structural features of a leg portion.

In one embodiment, the point encoder 411, through a Kernel Point Convolution Layer, by processing point clouds 511a, 512a, 513a, and 514a, may extract (or generate) three-dimensional structural features of respective segments. That is, the point encoder 411 may convert point clouds 511a, 512a, 513a, and 514a respectively into compressed latent feature vectors of a specific dimension (for example, a 256-dimensions).

The node encoder 410, by processing latent feature vectors for respective ones of the plurality of segments 511, 512, 513, and 514 extracted through the point encoder 411 and spatial attribute information for respective ones of the plurality of segments 511, 512, 513, and 514, may extract node features (1) for respective ones of the plurality of segments.

More specifically, the node encoder 410, by combining latent feature vectors for respective ones of the plurality of segments 511, 512, 513, and 514 and spatial attribute information for respective ones of the plurality of segments 511, 512, 513, and 514, may extract node features for respective ones of the plurality of segments. Such node features may include at least one of point-cloud information processed through the point encoder 411 (for example, spatial positions and shape information of points constituting respective segments, etc.), coordinate standard deviation (for example, a distribution of points in a segment), sizes and volumes of bounding boxes (for example, a size and a volume of a thing corresponding to respective segments), and a maximum length of a bounding box (for example, a maximum length of a thing corresponding to respective segments).

That is, a node feature is information that includes a three-dimensional shape, structural information, and spatial information of a segment, and may be used to compare or classify the corresponding segment with other nodes.

Further, the three-dimensional scene graph generation system 1000 may input spatial attribute information (or spatial attribute-information differences) of adjacent segments among the plurality of segments 511, 512, 513, and 514 to the edge encoder 420.

More specifically, the three-dimensional scene graph generation system 1000 may specify segment pairs that are present at mutually adjacent positions among the plurality of segments 511, 512, 513, and 514, and, by calculating spatial attribute-information differences of the specified segment pairs, may input the differences to the edge encoder 420. For example, the three-dimensional scene graph generation system 1000 may input to the edge encoder 420 at least one of a center-coordinate difference, a coordinate standard-deviation difference, a bounding-box size difference, a bounding-box volume ratio, and a maximum-length ratio between adjacent segments (for example, 511 and 513).

The edge encoder 420, by using a Multi-layer Perceptron (MLP) 421, may process spatial attribute information between adjacent segments 511 and 513 (or spatial attribute information among a plurality of segments) and may extract an edge feature (eᵢⱼ) representing a relationship between adjacent segments 511 and 513.

In one embodiment, the edge encoder 420, by combining a center-coordinate difference, a coordinate standard-deviation difference, a bounding-box size difference, a bounding-box volume ratio, and a maximum-length ratio between adjacent segments 511 and 513, may generate a feature vector (φᵢⱼ, or an attribute-difference vector), and, by mapping the feature vector into a latent space by using the Multi-layer Perceptron 421, may extract an edge feature (eᵢⱼ).

That is, an edge feature is information representing a relationship between adjacent segments, and may reflect spatial differences and spatial interactions (for example, “is above,” “is between,” etc.) between adjacent segments. This may be utilized to learn connection relationships within a graph structure.

Meanwhile, in the present invention, node features and edge features are input to graph neural networks (S360), and, from the graph neural networks, a process of acquiring a local three-dimensional semantic scene graph (local 3D Semantic Scene Graph) including nodes corresponding to node features and edges corresponding to edge features may proceed (S370, see FIG. 3).

Further, in the present invention, through Graph Fusion, a process of merging a local three-dimensional semantic scene graph into a three-dimensional semantic scene graph (3D Semantic Scene Graph) stored in pre-specified storage may proceed (S380, see FIG. 3).

The three-dimensional scene graph generation model 400 may input to the graph neural networks 430 node features (for example, point-cloud information and size of a segment of “a chair”) acquired from the node encoder 410 and edge features (for example, a distance and a spatial relationship between “a chair” and “a table”) acquired from the edge encoder 420.

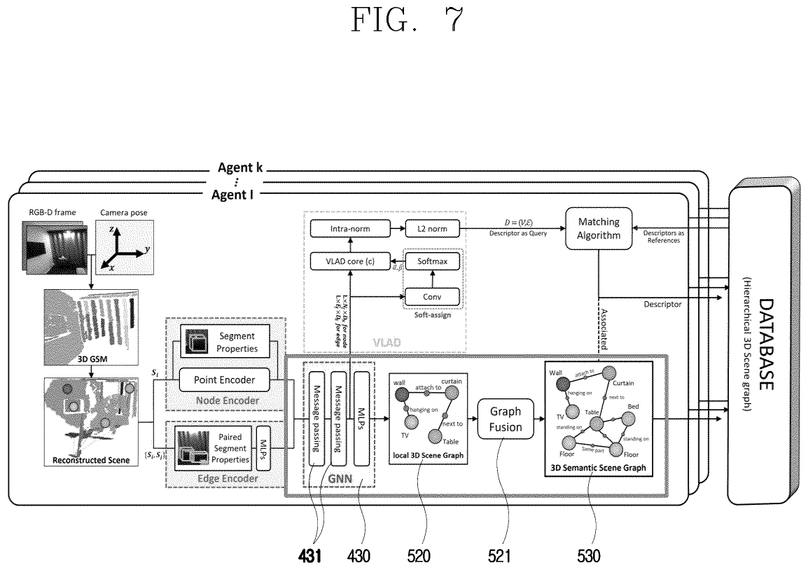

When node features and edge features are input, as illustrated in FIG. 7, the graph neural networks 430, by using a message passing layer 431 and/or a message passing algorithm, may respectively update node features and edge features.

In one embodiment, in an update process through the message passing layer 431, respective node features for respective ones of a plurality of segments 511, 512, 513, and 514 may receive information from neighbor nodes connected to themselves. The received information may include features of respective neighbor nodes and edge features representing relationships with neighbor nodes. Further, by aggregating received information and combining the received information with own existing features, a new node feature may be updated. The respective edge features for respective ones of the plurality of segments 511, 512, 513, and 514 also may be updated based on features of connected nodes.

That is, each node feature is updated based on own current feature and a relationship with neighbor nodes, and each edge feature may be updated by using a current feature of a node connected to itself and an existing edge feature.

In this case, the three-dimensional scene graph generation model 400, in an update process through the message passing layer 431, may acquire node labels and edge labels for respective ones of the plurality of segments 511, 512, 513, and 514. For example, the three-dimensional scene graph generation model 400, based on updated node features and updated edge features, may acquire node-label information (for example, “chair,” “table,” “window,” etc.) for respective ones of the plurality of segments 511, 512, 513, and 514, and edge-label information (for example, “is next to,” “is above,” etc.).

Further, as illustrated in FIG. 7, the graph neural networks 430, by using updated node features and updated edge features through an update stage, may generate the local three-dimensional semantic scene graph 520 (or a first local three-dimensional semantic scene graph) for a specific space.

The graph neural networks 430 may generate the local three-dimensional semantic scene graph 520 in which nodes corresponding to respective ones of the plurality of segments 511, 512, 513, and 514 and edges corresponding thereto have (or include) labels. The local three-dimensional semantic scene graph 520 may be configured to include nodes corresponding to updated node features and edges corresponding to updated edge features.

In this case, labels granted to respective nodes and respective edges included in the local three-dimensional semantic scene graph 520 (or labels that respective nodes and respective edges have) may be node labels and edge labels acquired through the update process through message passing described above. Such node labels and edge labels are granted to respective nodes and respective edges corresponding to respective node labels and respective edge labels, and the local three-dimensional semantic scene graph 520 including a node label corresponding to each node and an edge label corresponding to each edge may be generated.

That is, node labels and edge labels may be understood as semantic data (Semantic) representing types of things and relationships among things in a three-dimensional scene graph, respectively. Such node labels and edge labels may be used to visually understand a three-dimensional environment and to infer a context in a scene.

Meanwhile, the three-dimensional scene graph generation model 400, by using updated node features and updated edge features, may extract a descriptor of a specific space (the first space R1).

The three-dimensional scene graph generation model 400, by embedding updated node features and updated edge features, may generate a first embedding vector for updated node features and a second embedding vector for updated edge features.

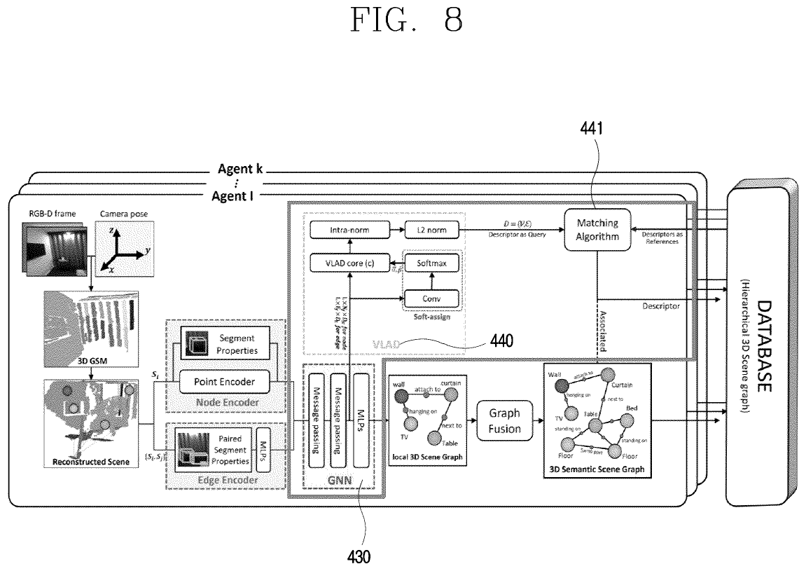

Further, as illustrated in FIG. 8, the three-dimensional scene graph generation model 400 may process the first embedding vector and the second embedding vector as inputs of a Vector of Locally Aggregated Descriptors (VLAD) module 440. The VLAD module 440, by using the first embedding vector and the second embedding vector, may calculate a global descriptor of the first space R1 explored by an agent, and, based on a calculation result, may extract a descriptor of the first space R1. That is, the VLAD module 440, by processing the first embedding vector and the second embedding vector, may extract a descriptor of the first space R1.

Further, the three-dimensional scene graph generation model 400 (or a three-dimensional scene graph generation system) may compare similarity between an extracted descriptor of the first space R1 and descriptors of other spaces stored in pre-specified storage.

The three-dimensional scene graph generation model 400, by using a descriptor of the first space R1 as a query, may compare similarity between the descriptor of the first space R1 and descriptors of the large-scale space 500 stored in pre-specified storage.

More specifically, the three-dimensional scene graph generation model 400 may compare and determine similarity between the descriptor of the first space R1 and descriptors of the large-scale space 500 stored in pre-specified storage. The three-dimensional scene graph generation model 400, by using a Euclidean distance and/or a cosine similarity, may measure (or calculate) similarity between the descriptor of the first space R1 and descriptors stored in pre-specified storage. For example, as a value of similarity becomes smaller, two descriptors may be understood as including information about mutually similar spaces.

In this case, the three-dimensional scene graph generation model 400, by using a matching algorithm 441, may specify a candidate group having high similarity to the descriptor of the first space R1 among the descriptors of the large-scale space 500 stored in pre-specified storage. Here, specification of a candidate group having high similarity may be specified based on a preset threshold. As one example, a preset threshold in the present invention may be set to “0.75 or more.” However, a numerical value of the preset threshold in the present invention is not necessarily limited thereto, and it is obvious that the preset threshold may be variously changed by an administrator of the three-dimensional scene graph generation system 1000 or by the three-dimensional scene graph generation system 1000 itself.

In this regard, as a result of a similarity comparison, in a case where a specific descriptor that satisfies the preset threshold exists among the descriptors of the large-scale space 500 stored in pre-specified storage, the three-dimensional scene graph generation model 400 may determine that a space related to the specific descriptor is the same space as the first space R1. Here, a specific descriptor may be existing data stored in pre-specified storage in correspondence to a specific space (the first space R1). This may be understood as a space that other agents already have explored.

In this case, the three-dimensional scene graph generation model 400, by replacing a specific descriptor as the descriptor of the first space R1 and storing the specific descriptor, and, through the graph fusion 521, may merge the local three-dimensional semantic scene graph 520 into the three-dimensional semantic scene graph 530 stored in pre-specified storage. For example, the three-dimensional scene graph generation model 400 may integrate nodes and edges to remove duplicated information or may reflect newly generated more accurate information.

Differently from this, as a result of a similarity comparison, when a specific descriptor satisfying a preset threshold does not exist among the descriptors of the large-scale space 500 stored in pre-specified storage, the three-dimensional scene graph generation model 400 may determine that the descriptor of the first space R1 is a descriptor of a new space without a history of being explored by other agents.

In this case, the three-dimensional scene graph generation model 400 may store the descriptor of the first space R1 in pre-specified storage, and, through the graph fusion 521, may update the three-dimensional semantic scene graph 530 stored in pre-specified storage with the local three-dimensional semantic scene graph 520. This may be understood as nodes and edges for a new space being added (or updated) to the three-dimensional semantic scene graph 530.

Meanwhile, in the above-described process, a process of generating a three-dimensional scene graph for a specific space (the first space R1) explored by the first agent 310 was described with emphasis; however, in the present invention, in a case where a plurality of agents simultaneously explore a plurality of spaces, three-dimensional scene graphs for the plurality of spaces may be generated and updated in real time. However, since a process of generating a three-dimensional scene graph was described in more detail above, hereinafter, to avoid redundancy, a brief description will be made.

While the first agent 310 explores the first space R1 among a plurality of spaces R1 to R8 included in the large-scale space 500, the second agent 320 may simultaneously explore the second space R2 different from the first space R1.

The three-dimensional scene graph generation system 1000, from the second agent 320, may acquire RGB-D data and camera pose data for the second space R2, and, by using the RGB-D data and the camera pose data, may segment the second space R2 into a plurality of segments and may generate a three-dimensional global segmentation map (or a second three-dimensional global segmentation map) including the plurality of segmented segments.

Further, the three-dimensional scene graph generation system 1000, from the three-dimensional global segmentation map for the second space R2, may extract point clouds of respective ones of the plurality of segments and spatial attribute information of respective ones of the plurality of segments, and may process the extracted point clouds and the spatial attribute information as respective inputs of the node encoder 410 and the edge encoder 420. The three-dimensional scene graph generation system 1000, from the node encoder 410 and the edge encoder 420, respectively, may acquire node features for respective ones of the plurality of segments and edge features representing relationships among the plurality of segments, and may input the acquired node features and edge features to the graph neural networks 430.

In the graph neural networks 430, through a message passing layer, node features and edge features may be respectively updated, and, by using the updated node features and the updated edge features, a local three-dimensional semantic scene graph for the second space R2 (or a second local three-dimensional semantic scene graph) may be generated. In this case, the three-dimensional scene graph generation system 1000, by using the updated node features and the updated edge features, may extract a descriptor of the second space R2.

Further, the three-dimensional scene graph generation system 1000 may compare similarity between the extracted descriptor of the second space R2 and descriptors of the large-scale space 500 stored in pre-specified storage.

As a result of a similarity comparison, in a case where a specific descriptor satisfying a preset threshold exists among descriptors of the large-scale space 500 stored in pre-specified storage, the three-dimensional scene graph generation system 1000 may store the specific descriptor by replacing the descriptor of the second space R2, and, through the graph fusion, may merge a second local three-dimensional semantic scene graph into a three-dimensional semantic scene graph stored in pre-specified storage.

Differently from this, as a result of a similarity comparison, in a case where a specific descriptor satisfying a preset threshold does not exist among descriptors of the large-scale space 500 stored in pre-specified storage, the three-dimensional scene graph generation system 1000 may store the descriptor of the second space R2 and the second local three-dimensional semantic scene graph in pre-specified storage, and, through the graph fusion, may update a three-dimensional semantic scene graph stored in pre-specified storage with a local three-dimensional semantic scene graph.

That is, the three-dimensional scene graph generation system 1000 may merge and/or update, into a three-dimensional semantic scene graph stored in pre-specified storage, local three-dimensional semantic scene graphs (a first local three-dimensional semantic scene graph and a second local three-dimensional semantic scene graph) for respective ones of a plurality of spaces (the first space R1 and the second space R2) explored in real time by a plurality of agents (the first agent 310 and the second agent 320) cooperating with each other. Such a three-dimensional semantic scene graph may be integrated (or updated) into a hierarchical three-dimensional scene graph (Hierarchical 3D Scene Graph) stored in pre-specified storage.

As such, in the present invention, by using multiple agents rather than a single agent, a three-dimensional scene graph may be rapidly generated in real time even in a large-scale space. That is, in the present invention, even if data is collected simultaneously from multiple agents, data may be processed in real time to generate and update a three-dimensional scene graph for a large-scale space.

As such, in the present invention, as three-dimensional scene graphs for spaces explored by respective agents are gradually merged, an entire three-dimensional scene graph may be gradually expanded. A merged graph represents a three-dimensional semantic scene graph for an entire space composed of information collected by multiple agents cooperating with each other, and may visually represent positions and relationships of things in a space. Such a three-dimensional scene graph plays an important role in understanding various things and their relationships within a space and in systematically identifying a space.

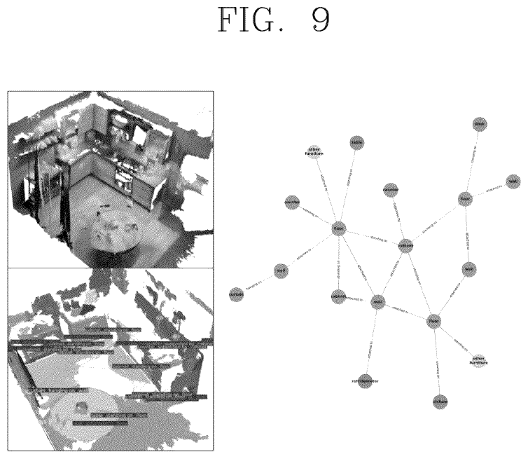

Meanwhile, with reference to FIG. 9, one example of a three-dimensional scene graph generated in a three-dimensional scene graph generation system according to the present invention can be found. A three-dimensional scene graph according to the present invention represents each object as a node, and relationships among objects exist connected as edges. For example, a “floor” node represents a kitchen floor, and various things such as “table,” “wall,” “sink,” and the like are confirmed to be connected through relationships with “floor.” Also, connections among nodes reflect positional relationships and interaction relationships, and, for example, “wall” and “floor” are connected, or “table” and “chair” are connected, thereby visually representing a structure of a space. This indicates that a three-dimensional scene graph generation model (or system) according to the present invention may well recognize things within a space and may systematically express relationships among the things.

Also, with reference to FIG. 10(a), three-dimensional scene graph generation performance of a three-dimensional scene graph generation model (for example, “MA3DSG”) according to the present invention can be found. A three-dimensional scene graph generation model according to the present invention is confirmed to exhibit higher performance in accuracy than existing models while significantly shortening a generation time of a three-dimensional scene graph. This is because, in the present invention, by parallel-processing tasks through multiple agents, an efficient three-dimensional scene graph may be generated.

Subsequently, with reference to FIG. 10(b), space (or place) recognition performance of a three-dimensional scene graph generation model according to the present invention can be found. Here, an overlap ratio (for example, a ratio at which an agent redundantly visits the same space) and recognition performance according to the number of agents were measured, and it can be confirmed that a three-dimensional scene graph generation model according to the present invention shows overall high recognition performance regardless of an overlap ratio and the number of agents, and, particularly, maintains high accuracy when visiting a new place for the first time.

Further, with reference to FIG. 11, one example of results of measuring time required for three-dimensional scene graph generation under various conditions can be found. This indicates that the method and system 1000 for generating a three-dimensional scene graph using multiple agents according to the present invention may perform three-dimensional scene graph generation efficiently. By increasing the number of agents, the generation time is greatly reduced, which may be very useful to rapidly scan and graph a large-scale indoor space.

As described above, according to the method and system for generating a three-dimensional scene graph using multiple agents according to the present invention, by multiple agents cooperating with each other to explore quickly in real time large-scale spaces, a hierarchical three-dimensional scene graph for large-scale spaces may be generated (or constructed) quickly and efficiently.

Also, according to the method and system for generating a three-dimensional scene graph using multiple agents according to the present invention, multiple agents may simultaneously explore different spaces (or zones) within a large-scale space, and may collect and share data for different spaces. Through this, in the present invention, large-scale spaces may be analyzed quickly, and a three-dimensional scene graph for large-scale spaces may be generated.

Further, according to the method and system for generating a three-dimensional scene graph using multiple agents according to the present invention, by using multiple agents, data for large-scale spaces may be collected, and object and relationship information within a large-scale space may be stored hierarchically in a database. Through this, in the present invention, a three-dimensional scene graph for large-scale environments may be generated efficiently, and through the constructed database, an environment capable of effectively understanding and integrally managing large-scale spaces may be provided.

In addition, according to the method and system for generating a three-dimensional scene graph using multiple agents according to the present invention, by storing in the database the data for spaces that multiple agents respectively have explored, even if multiple agents visit the same space multiple times, the data may be managed efficiently. Through this, in the present invention, information acquired by each agent is not duplicated, and is accurately merged and may be reflected in a final three-dimensional scene graph.

That is, the method and system for generating a three-dimensional scene graph using multiple agents according to the present invention stores, in the database, data for large-scale spaces collected (or acquired) by using multiple agents, and may generate and update in real time a three-dimensional scene graph for large-scale spaces. The present invention may be utilized in various application fields such as security and surveillance systems, a robotics field, augmented reality (AR) and virtual reality (VR).

Meanwhile, the present invention described above may be executed by one or more processes on a computer and implemented as a program that may be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the alternations within the equivalent scope of the present invention belong to the scope of the present invention.

What is claimed is:

1. A method for generating a three-dimensional scene graph of a three-dimensional scene graph generation system including a plurality of agents exploring a large-scale space, the method comprising:
acquiring, from at least one agent among the plurality of agents, RGB-D data and camera pose data for a specific space among the large-scale space;
segmenting, by using the RGB-D data and the camera pose data, the specific space into a plurality of segments, and generating a three-dimensional global segmentation map including the plurality of segmented segments;
extracting, from the three-dimensional global segmentation map, point clouds of respective ones of the plurality of segments and spatial attribute information of respective ones of the plurality of segments;
inputting the extracted point clouds and the spatial attribute information to an encoder;
acquiring, from the encoder, node features for respective ones of the plurality of segments and edge features representing relationships among the plurality of segments;
inputting the node features and the edge features to graph neural networks;
acquiring, from the graph neural networks, a local three-dimensional semantic scene graph including nodes corresponding to the node features and edges corresponding to the edge features; and
merging, through graph fusion, the local three-dimensional semantic scene graph into a three-dimensional semantic scene graph stored in pre-specified storage.

2. The method of claim 1, wherein the encoder comprises at least one among a node encoder that processes the point clouds and the spatial attribute information of respective ones of the plurality of segments, and an edge encoder that processes the spatial attribute information of adjacent-segment pairs among the plurality of segments.

3. The method of claim 2, wherein the inputting to the encoder comprises:
inputting the point clouds and the spatial attribute information of respective ones of the plurality of segments to the node encoder; and
inputting the spatial attribute information of the adjacent-segment pairs to the edge encoder, and
wherein the spatial attribute information comprises at least one of center coordinates of the plurality of segments, and sizes and volumes of bounding boxes including the plurality of segments.

4. The method of claim 3, wherein the node encoder comprises a point encoder that processes the point clouds of respective ones of the plurality of segments, and
wherein the acquiring of the node features comprises:
generating latent feature vectors for respective ones of the plurality of segments by processing the point clouds of respective ones of the plurality of segments in the point encoder;
extracting the node features for respective ones of the plurality of segments by processing the latent feature vectors and the spatial attribute information in the node encoder; and
acquiring the node features extracted from the node encoder.

5. The method of claim 2, wherein the acquiring of the edge features comprises:
extracting the edge features representing relationships between the adjacent segments by processing the spatial attribute information between the adjacent segments in the edge encoder; and
acquiring the edge features extracted from the edge encoder.

6. The method of claim 1, wherein the acquiring of the local three-dimensional semantic scene graph comprises:
updating the node features and the edge features, respectively, in a message passing layer of the graph neural networks;
generating, in the graph neural networks, the local three-dimensional semantic scene graph by using the updated node features and the updated edge features through the updating; and
acquiring the local three-dimensional semantic scene graph generated from the graph neural networks, and
wherein the local three-dimensional semantic scene graph comprises nodes corresponding to the updated node features and edges corresponding to the updated edge features.

7. The method of claim 6, further comprising:
extracting a descriptor of the specific space by using the updated node features and the updated edge features; and
comparing similarity between the extracted descriptor of the specific space and descriptors of the large-scale space stored in the pre-specified storage,
wherein the extracting of the descriptor of the specific space comprises:
generating a first embedding vector for the updated node features and a second embedding vector for the updated edge features by embedding the updated node features and the updated edge features;
inputting the first embedding vector and the second embedding vector to a Vector of Locally Aggregated Descriptors (VLAD) module; and
extracting the descriptor of the specific space by processing the first embedding vector and the second embedding vector in the VLAD module.

8. The method of claim 7, wherein, as a result of the similarity comparison, in a case where a specific descriptor satisfying a preset threshold exists among the descriptors of the large-scale space stored in the pre-specified storage, the specific descriptor is stored by replacing the descriptor of the specific space, and, through the graph fusion, the local three-dimensional semantic scene graph is merged into the three-dimensional semantic scene graph stored in the pre-specified storage, and
wherein, as the result of the similarity comparison, in a case where the specific descriptor satisfying the preset threshold does not exist among the descriptors of the large-scale space stored in the pre-specified storage, the descriptor of the specific space and the local three-dimensional semantic scene graph are stored in the pre-specified storage, and, through the graph fusion, the local three-dimensional semantic scene graph is updated into the three-dimensional semantic scene graph stored in the pre-specified storage, and
wherein the specific descriptor is existing data stored in the pre-specified storage in correspondence to the specific space.

9. A system for generating a three-dimensional scene graph including a plurality of agents exploring a large-scale space, wherein the system:
acquires, from at least one agent among the plurality of agents, RGB-D data and camera pose data for a specific space among the large-scale space;
segments, by using the RGB-D data and the camera pose data, the specific space into a plurality of segments, and generating a three-dimensional global segmentation map including the plurality of segmented segments;
extracts, from the three-dimensional global segmentation map, point clouds of respective ones of the plurality of segments and spatial attribute information of respective ones of the plurality of segments;
inputs the extracted point clouds and the spatial attribute information to an encoder;
acquires, from the encoder, node features for respective ones of the plurality of segments and edge features representing relationships among the plurality of segments;
inputs the node features and the edge features to graph neural networks;
acquires, from the graph neural networks, a local three-dimensional semantic scene graph including nodes corresponding to the node features and edges corresponding to the edge features; and
merges, through graph fusion, the local three-dimensional semantic scene graph into a three-dimensional semantic scene graph stored in pre-specified storage.

10. A program stored on a computer-readable recording medium that is executed by one or more processors in an electronic device, the program comprising instructions for performing:
acquiring, from at least one agent among a plurality of agents, RGB-D data and camera pose data for a specific space among large-scale spaces;
segmenting, by using the RGB-D data and the camera pose data, the specific space into a plurality of segments, and generating a three-dimensional global segmentation map including the plurality of segmented segments;
extracting, from the three-dimensional global segmentation map, point clouds of respective ones of the plurality of segments and spatial attribute information of respective ones of the plurality of segments;
inputting the extracted point clouds and the spatial attribute information to an encoder;
acquiring, from the encoder, node features for respective ones of the plurality of segments and edge features representing relationships among the plurality of segments;
inputting the node features and the edge features to graph neural networks;
acquiring, from the graph neural networks, a local three-dimensional semantic scene graph including nodes corresponding to the node features and edges corresponding to the edge features; and
merging, through graph fusion, the local three-dimensional semantic scene graph into a three-dimensional semantic scene graph stored in pre-specified storage.
